(19) United States
(12) Patent Application Publication
(10) Pub. No.: US 2017/0161699 A1
(43) Pub. Date: Jun. 8, 2017

(54) Method and Device for Achieving Remote Payment

(71) Applicant: ZTE CORPORATION, Shenzhen City, Guangdong Province (CN)

(72) Inventor: Chuanxi WU, Shenzhen (CN)

(21) Appl. No.: 15/325,722

(22) PCT Filed: Sep. 18, 2014
(86) PCT No.: PCT/CN2014/086837

§ 371 Date: Jan. 12, 2017

(30) Foreign Application Priority Data
Jul. 16, 2014 (CN) 201410340074.X

(51) Int. Cl. G06Q 20/10; G06F 21/77; G06Q 20/40; G06Q 20/34; G06Q 20/36

(52) U.S. Cl. CPC G06Q 20/105; G06Q 20/341; G06Q 20/3563; G06Q 20/3674; G06Q 20/40; G06F 21/77; G06F 21/445

(57) ABSTRACT

The present document discloses a method and device for implementing a remote payment. The method includes: a smart card of a mobile terminal containing a USB Key, and arranging a USB Key processing unit inside the smart card; and further includes: sending, by a payment application client, a command related to the USB Key; converting, by a converter drive unit, a command related to the USB Key to a command in the format of an application protocol data unit (APDU); and receiving and reading, by the USB Key processing unit, the command in the format of an APDU to activate the USB Key and execute a remote payment instruction.

### TECHNICAL FIELD

The present document relates to the field of mobile payment, and more particularly to a remote payment implementation method and apparatus.

### BACKGROUND OF THE RELATED ART

Along with the rapid popularization of smart phones, the mobile internet will rapidly develop accordingly. Mobile payment, serving as an important application of the mobile internet, is highly focused by the whole society based on convenience, shortcut and fashion of the mobile payment. The mobile payment is a mode of electronic payment also called as phone payment, and refers to transaction payment between both sides of a transaction for a certain commodity or service via a mobile communication network or a near field communication technology by taking a mobile terminal device as a carrier. According to different specific payment interaction flows, the mobile payment may be divided into near field payment and remote payment. The near field payment refers to a payment mode of a mobile terminal completing a payment process at a local place or by accessing a receipt network via a noncontact receiving terminal. The remote payment refers to a method for purchasing, by a user who does not face a merchant, a commodity or service on a payment application platform by using the mobile terminal, confirming payment by interaction between a wireless communication network and a background server, and completing payment processing at the server. The mobile payment market of China develops rapidly. It is shown, according to a report from an EnfoDesk, that the transaction scale of the mobile payment market will be expected to reach 385 billion Yuan RMB until 2014, and the scale of users will reach 0.387 billion, in which remote payment services occupy a majority of market shares.

At present, main forms of the remote payment include a remote payment based on Mobile Taobao and a remote payment based on an external card swiping device.

The payment based on Mobile Taobao refers to a method that a mobile terminal receives a short message and a user implements payment via the Internet. By using this solution, it is necessary to pre-establish a clientage, and a acquirer is responsible for managing the clientage. A specific flow substantially refers to that: when the user selects mobile phone payment, the user inputs a bound phone number; and, this mobile phone will receive a short message with a verification web page link, the web page is opened for related information about a bank card used for payment and a preset payment password, then the payment is completed after verification. The security level of this solution is moderate, and this solution is only suitable for micropayment or physical purchasing on a Business-to-Consumer (B2C) website. The payment based on Mobile Taobao does not meet the requirement of security for large payment and a higher security payment application related to the bank card.

The payment based on the external card swiping device refers to that: a card swiping device is inserted into an audio jack of a mobile phone or a tablet computer, the user completes a card swiping flow of a bank card on the card swiping device to complete payment. By using the mode of payment based on the external card swiping device, rich remote payment services may be enjoyed without opening an online bank. At present, the payment based on the external card swiping device is applied to a mobile terminal having an operating system such as iOS, Android, and so on. However, by means of an external card swiping payment mode, as long as the card swiping device is purchased, the card swiping process can be realized. It is necessary to increase the payment cost, and the development of the payment based on the external card swiping device is affected. Besides, using the external card swiping payment mode has a risk of maliciously collecting, by an imitated merchant, user bank card information by using the card swiping device, thus reducing the security of a payment environment.

Along with intelligence of a mobile phone, IP of a mobile network and diversification of a platform, the security problems of the mobile internet and the smart terminal emerge increasingly. The mobile network is a communication network established on an opened unreliable physical channel, and meanwhile, because a mobile network secure protocol has leaks, the mobile network is easily attacked by interception from wired and wireless environments, channel interception, fraud, and the like. Malicious programs, remote controls, network attacks and the like on a wired network are continuously spread to the mobile internet, and the mobile terminal and the payment services are closely related to user benefits, thus the problems of sensitive data leakage and account information stealing, which are caused by interception, card cloning, man-in-the-middle attack and the like, are serious increasingly.

As for the remote payment, due to involving large payment and transfer, this class of applications has higher security level requirements to feasibly guarantee the fund security of users. Moreover, in a transaction process, it is necessary to ensure the truth and effectiveness of the user identity and transaction requests, thus avoiding occurrences of stealing of an account, “fishing” and other circumstances. By means of the remote payment based on Mobile Taobao and the remote payment based on an external card swiping device, there are problems, such as in that: either security guarantee is lacking, the security level is lower, and the usage range is narrower; or, due to an additional device is purchased as needed, the cost is higher and the security risk of malicious collection of user bank card information is caused. Thus, as for the above remote payments, popularization and application are not facilitated.

### CONTENT OF THE INVENTION

The technical problem solved by the embodiments of the present document is to provide a method and apparatus for implementing a remote payment, so as to improve the security of the remote payment, and meanwhile, it is unnecessary to add a hardware apparatus and thus the cost can be saved.

To solve the above technical problem, the technical solution is adopted as follows.

A method for implementing a remote payment, is applied to a mobile terminal of which a smart card contains a USB Key, and a USB Key processing unit is disposed inside the smart card; the method includes:
sending, by a payment application client, a command related to the USB Key;
converting, by a conversion drive unit, the command related to the USB Key to a command in an Application Protocol Data Unit, APDU, format; and
receiving and reading, by the USB Key processing unit, the command in the APDU format to activate the USB Key and execute a remote payment instruction.

Alternatively, after the payment application client sends the command related to the USB Key, the method further includes:
judging whether the command related to the USB Key is the command in the APDU format which is capable of being identified by the USB Key processing unit; and
when the command related to the USB Key is the command in the APDU format which is capable of being identified by the USB Key processing unit, directly sending this command to the USB Key processing unit, and executing the step of receiving and reading, by the USB Key processing unit, the command in the APDU format.

Alternatively, the step of converting the command related to the USB Key to the command in the APDU format includes:
parsing the command related to the USB Key, filling parsed command information in an APDU corresponding position and filling a related parameter according to a preset APDU format.

Alternatively, the step of receiving and reading, by the USB Key processing unit, the command in the APDU format to activate the USB Key and execute the remote payment instruction includes:
the USB Key processing unit, according to the received and read command in the APDU format, activating the USB Key, and executing an operation of an encryption, a decryption or a key pair generation corresponding to the remote payment.

Alternatively, before the payment application client sends the command related to the USB Key, the method further includes:
when the smart card is initially set, establishing an extended element file of the USB Key, and installing the payment application client based on the established extended element file;
herein, the extended element file is used for storing a certificate supporting a USB Key function.

Alternatively, after the USB Key processing unit executes the remote payment instruction corresponding to the command in the APDU format, the method further includes: feeding an execution result back to the payment application client via the conversion drive unit.

Alternatively, the command in the APDU format is transmitted via a logic channel; and
the method further includes: after feeding the execution result back to the payment application client, closing the logic channel.

Alternatively, before the USB Key processing unit receives and reads the command in the APDU format, the method further includes:
receiving, by the smart card, a PIN2 code from a user, and judging whether the PIN2 code input by the user is consistent with a preset PIN2 code of the terminal; if consistent, considering that the PIN2 code input by the user is matched with the preset PIN2 code of the terminal, opening a USB Key function of the smart card to make it under an enabled state, and activating the USB Key; and
if the input PIN2 code is not matched with the preset PIN2 code and non-match times reach preset times, prohibiting all of subsequent payment operations.

An apparatus for implementing a remote payment, includes: a smart card, a conversion drive unit, and a payment application client, herein,
the payment application client is arranged to: send a command related to a USB Key;
the conversion drive unit is arranged to: after receiving the command related to the USB Key, convert the command related to the USB Key to a command in an Application Protocol Data Unit, APDU, format;
the smart card contains the USB Key, and is provided with a USB Key processing unit, herein,
the USB Key processing unit is arranged to: receive and read the command in the APDU format to activate the USB Key and execute a remote payment instruction.

Alternatively, the payment application client is further arranged to: after sending the command related to the USB Key, judge whether the command related to the USB Key is the command in the APDU format which is capable of being identified by the USB Key processing unit; and
send said command related to the USB Key directly to the USB Key processing unit when the command related to the USB Key is the command in the APDU format which is capable of being identified by the USB Key processing unit.

Alternatively, the conversion drive unit is arranged to, after receiving the command related to the USB Key, convert the command related to the USB Key to the command in the APDU format by a following way: parsing the command related to the USB Key, filling information about the parsed command related to the USB Key in an APDU corresponding position and filling a related parameter according to a preset APDU format.

Alternatively, the USB Key processing unit is arranged to receive and read the command in the APDU format to activate the USB Key and execute the remote payment instruction by a following way: receiving and reading the command in the APDU format to activate the USB Key and execute an operation of an encryption, a decryption or a key pair generation corresponding to the remote payment.

Alternatively, the apparatus further includes a setting unit, arranged to: when the smart card is initially set, establish an extended element file of the USB Key, and install the payment application client based on the established extended element file;
herein, the extended element file is used for storing a certificate supporting a USB Key function.

Alternatively, the apparatus further includes a feedback unit, arranged to: feed an execution result of executing the command in the APDU format back to the payment application client via the conversion drive unit after the USB Key processing unit executes the operation corresponding to the command in the APDU format.

Alternatively, the apparatus further includes a logic channel unit, arranged to: transmit the command in the APDU format by configuring a logic channel; and close the logic channel after the feedback unit feeds the execution result back.

Alternatively, the apparatus further includes a security verification unit, arranged to: before the USB Key processing unit receives and reads the command in the APDU format, receive a PIN2 code from a user, and judge whether the PIN2 code input by the user is consistent with a preset PIN2 code of the terminal; if consistent, consider that the PIN2 code input by the user is matched with the preset PIN2 code of the terminal, and open a USB Key function of the smart card to make it under an enabled state; and
if the input PIN2 code is not matched with the preset PIN2 code and non-match times reach preset times, prohibit all of subsequent payment operations.

Alternatively, the smart card is: a Subscriber Identity Module (SIM) card, or a Universal Subscriber Identity Module (USIM) card, or a Removable User Identity Module (R-UIM) card, or a Secure Digital (SD) card, or a chip containing a secure module built in a mobile phone.

Compared with the related art, the technical solution provided by the present document includes that: the smart card of the mobile terminal contains the USB Key, and the USB Key processing unit is disposed inside the smart card. The technical solution further includes: sending by the payment application client the command related to the USB Key; converting by the conversion drive unit the command related to the USB Key to the command in the APDU format; and receiving and reading by the USB Key processing unit the command in the APDU format to activate the USB Key and execute the remote payment instruction. With the above technical solution, it is ensured that the remote payment is implemented securely without additional hardware cost by configuring the USB Key on the smart card of the mobile terminal and receiving from the smart card the command related to the USB Key for remote payment. Further, the user is securely verified by means of the PIN2 code, thus improving the security of the remote payment.

### BRIEF DESCRIPTION OF DRAWINGS

The accompany drawings are used to provide further understanding of the technical solution of the present application, and form a part of the specification. The accompany drawings and the embodiments of the present application are used to explain the technical solutions of the present application together, and do not form limits to the technical solution of the present application.

FIG. 1 is a flowchart of a method for implementing a remote payment according to an embodiment of the present document;

FIG. 2 is a structure diagram of an apparatus for implementing a remote payment according to an embodiment of the present document; and

FIG. 3 is a flowchart of a method for implementing a remote payment according to an embodiment of the present document.

### PREFERRED EMBODIMENTS OF THE PRESENT INVENTION

The embodiments of the present application will be illustrated in detail below in combination with the accompany drawings. It is required to illustrate that the embodiments in the present application and the features in the embodiments can be randomly combined with each other without conflict.

There are multiple identity authentication technologies commonly used in the mobile internet at present. These identity authentication technologies have different operation modes, different security levels, and may be applied to different application scenarios. These identity authentication technologies include a static account password, WAP authentication, a dynamic password and a file digital certificate, etc. The file digital certificate is in the highest security level and meanwhile has a bidirectional authentication mechanism and non-repudiation, thereby the file digital certificate is an authentication mode which is more suitable for a high-security internet application. A USB Key authentication mode used by a network bank is the most widespread mode of security authentication via a digital certificate currently. Compared with the file digital certificate mode, a certificate of the USB Key authentication mode and a key of a user are stored by using hardware, and therefore illegal access can be avoided.

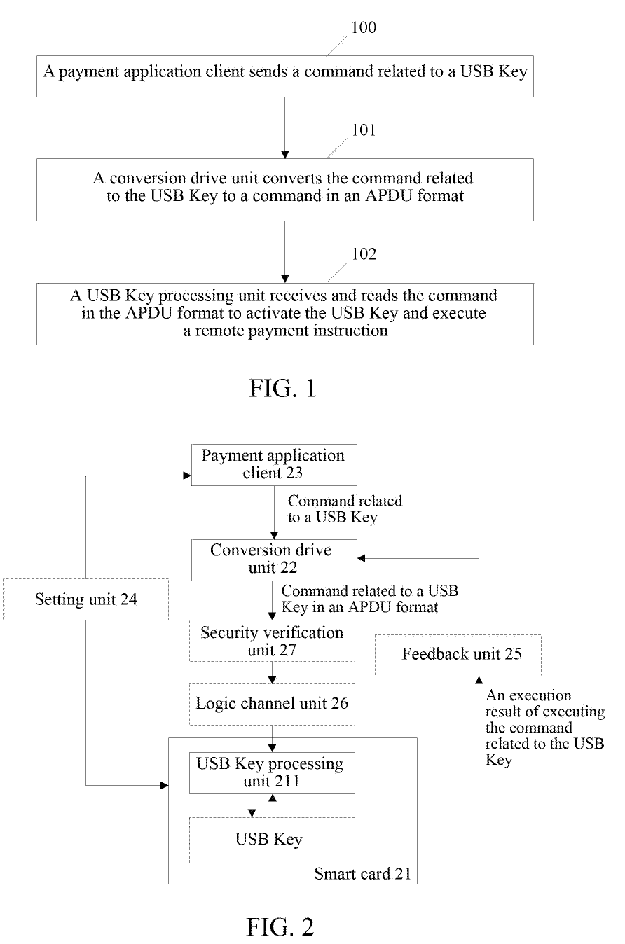

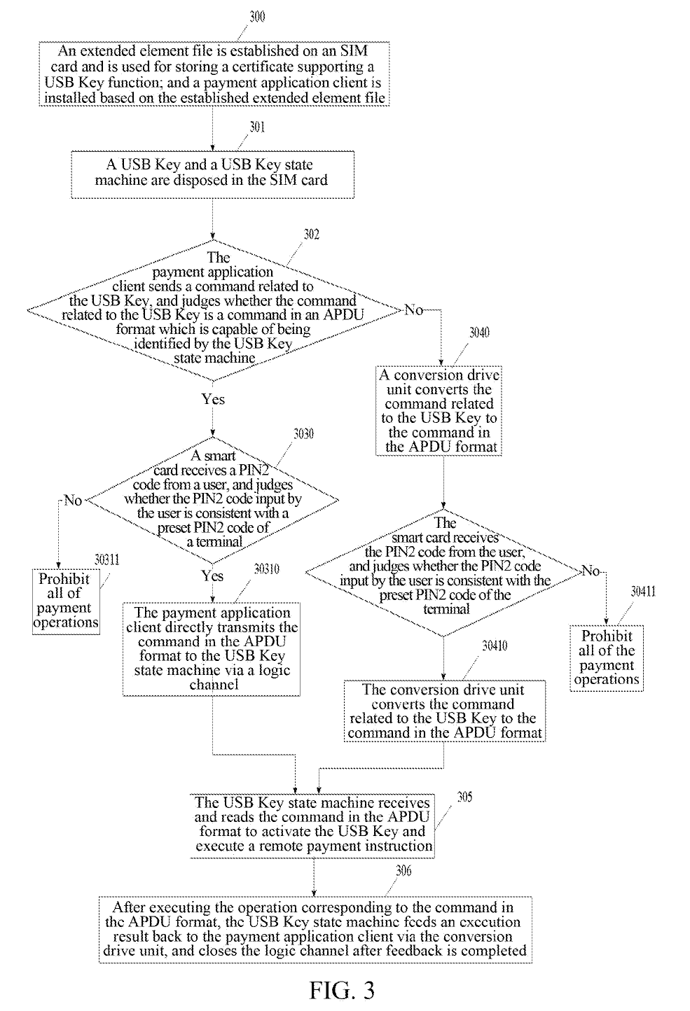

FIG. 1 is a flowchart of a method for implementing a remote payment according to the present document. Herein, a smart card of a mobile terminal contains a USB Key, and a USB Key processing unit is disposed inside the smart card. As shown in FIG. 1, the method includes the following steps.

Step 100: a payment application client sends a command related to the USB Key.

Before this step, the method further includes that:
when the smart card is initially set, an extended element file of the USB Key is established, and the payment application client based on the established extended element file is installed.

Herein, the extended element file is used for storing a certificate supporting a USB Key function.

It should be noted that, the command related to the USB Key refers to a command related to payment, such as encryption, decryption, and a key pair generation, etc., involved in a remote payment process. The USB Key is a hardware device of a USB interface. It is internally provided with a microprocessor or a smart chip, stores a private key of a user and a digital certificate, and authenticates the identity of the user by using a public key algorithm built in the USB Key. Because the private key of the user is stored in a password lock and cannot be read in any modes theoretically, the security of user authentication is ensured.

Step 101: the conversion drive unit converts the command related to the USB Key to a command in an APDU format.

In this step, the detail step of converting the command related to the USB Key to the command in the APDU format specifically includes parsing the command related to the USB Key and filling the parsed command information in an APDU corresponding position and a related parameter is filled according to a preset APDU format.

It should be noted that that an APDU complies with an ISO/IEC7816 standard, and is commonly known by those skilled in the art. An APDU command includes a command header and a command body. Herein the command header consists of five bytes. The first byte (instruction class CLA) is used to identify a specific application program class of an instruction. The second byte (instruction code INS byte) is used to indicate a specific instruction in a certain instruction class marked by the first byte, and the specific instruction is configured to complete a specific function. The fifth byte is used to store a total length of the APDU command body. The third and fourth bytes may be defined by the user self as needed, and the APDU command body is used to store a data file. According to the present document, the APDU command is expanded, two parameters CLA and INS in the APDU command are defined, an encryption function and a decryption function share the parameter INS, parameters P1 and P2 are used for distinguishing, specific parameters are shared, and belong to common general knowledge of those skilled in the art together with P1 and P2, and these contents are included in a chapter 9-9.1 in a 37^{th} page in a 3GPP11.11 protocol. The step of parsing the command related to the USB Key, filling the parsed information and filling the related parameter according to the APDU format falls within conventional technical means of those skilled in the art.

Step 102: the USB Key processing unit receives and reads the command in the APDU format to activate the USB Key and execute a remote payment instruction.

After the payment application client sends the command related to the USB Key, the method of the present document further includes: judging whether the command related to the USB Key is the command in the APDU format which is capable of being identified by the USB Key processing unit; and
when the command related to the USB Key is the command in the APDU format which is capable of being identified by the USB Key processing unit, directly sending said command to the USB Key processing unit (that is, step 101 is omitted), and executing the step of reading by the USB Key processing unit the command in the APDU format. When the command related to the USB Key is not the command in the APDU format which is capable of being identified by the USB Key processing unit, step 102 is executed. Here, how to judge whether the command related to the USB Key is the command in the APDU format which is capable of being identified by the USB Key processing unit is a conventional technical means of those skilled in the art.

It should be noted that the related mobile terminal does not include contents of performing the remote payment by setting the USB Key. Therefore, at present the mobile terminal does not have the command in the APDU format and supporting a remote payment function.

After the USB Key processing unit executes the operation corresponding to the command in the APDU format, the method of the present document further includes: feeding an execution result back to the payment application client via the conversion drive unit.

Alternatively, the command in the APDU format is transmitted via a logic channel.

The method of the present document further includes: after feeding the execution result back to the payment application client, closing the logic channel is closed.

It should be noted that the logic channel involved in transmission of the command in the APDU format via the logic channel is a channel which is well-known by those skilled in the art and used to securely transmit data information. This part of contents are recorded on page 32, section 6.4.27 in 3GPP 31.111.

The smart card in the present document is: an SIM card, or a USIM card, or an R-UIM card, or an SD card, or a chip which is built in a mobile phone and contains a secure module. Certainly, other corresponding cards, with the same functions to the above cards, belong to the smart card of the present document. Here, examples are only made for common smart cards.

The step of the USB Key processing unit receiving and reading the command in the APDU format to activate the USB Key and execute the remote payment instruction specifically includes: the USB Key processing unit, according to the received and read command in the APDU format, activating the USB Key, and executing an operation of an encryption, a decryption or a key pair generation corresponding to the remote payment.

Before the USB Key processing unit receives and reads the command in the APDU format, the method further includes: the smart card receiving a PIN2 code from the user, and judging whether the PIN2 code input by the user is consistent with a preset PIN2 code of the terminal, if consistent, considering that the PIN2 code input by the user is matched with the preset PIN2 code of the terminal, and opening a USB Key function of the smart card to make it under an enabled state.

If the input PIN2 code is not matched with the preset PIN2 code and non-match times reach preset times, all of subsequent payment operations are prohibited.

It should be noted that a process of a verification of the PIN2 code belongs to the verification function of the smart card itself. Because the USB Key is not set in the card according to the related remote payment, the verification function of the PIN2 code is only a technical solution for protecting communication information of the user, and is rarely executed and used by the user. In order to make the remote payment safer, when the USB Key is set inside the smart card, verification is executed by means of the PIN2 code, so the security of remote payment may be improved. In the related art, the communication information of the user is protected by means of the PIN2 code, the fixed times is generally set to count input errors. The match times in the present application is set according to an actual situation. When the remote payment requires a higher security level, a number value of preset times is smaller, for example, it is only allowed for two input errors. When the remote payment requires a general security level, a larger number value may be set, to prevent the PIN2 code from being locked due to a personal reason of a false operation.

FIG. 2 is a structure diagram of an apparatus for implementing a remote payment according to the present document. As shown in FIG. 2, the apparatus includes: a smart card 21, a conversion drive unit 22, and a payment application client 23.

The payment application client 23 is arranged to: send a command related to a USB Key.

The payment application client 23 is further arranged to: after sending the command related to the USB Key, judge whether the command related to the USB Key is the command in the APDU format which is capable of being identified by a USB Key processing unit of the smart card 21;
directly send the command related to the USB Key to the USB Key processing unit when the command is the command in the APDU format which is capable of being identified by the USB Key processing unit of the smart card 21; and
send the command related to the USB Key to the conversion drive unit when the command related to the USB Key is not the command in the APDU format which is capable of being identified by the USB Key processing unit of the smart card 21.

The conversion drive unit 22 is arranged to: receive the command related to the USB Key, and convert the command related to the USB Key to a command in an APDU format.

The conversion drive unit is arranged to, convert the command related to the USB Key to the command in the APDU format by a following way: parsing the command related to the USB Key, filling information about the parsed command related to the USB Key in an APDU corresponding position and filling a related parameter according to a preset APDU format.

The smart card 21 contains the USB Key, and is provided with the USB Key processing unit 211.

The USB Key processing unit 211 is arranged to: receive and read the command in the APDU format to activate the USB Key and execute a remote payment instruction.

The USB Key processing unit 211 is arranged to receive and read the command in the APDU format to activate the USB Key and execute the remote payment instruction by a following way: receiving and reading the command in the APDU format to activate the USB Key and execute an operation of an encryption, a decryption or a key pair generation corresponding to the remote payment.

The smart card 21 is: an SIM card, or a USIM card, or an R-UIM card, or an SD card, or a chip which is built in a mobile phone and contains a secure module. Here, the a chip which is built in a mobile phone and contains the secure module refers to a hardware dedicated chip adopted in the field of security application and having a secure function requirement. Commonly, there are some common dedicated chips used for security by financial mechanisms, which belongs to common general knowledge for those skilled in the art. Other cards with the same functions to the above cards belong to the smart card of the present document also. Here, examples are only made for common smart cards.

The apparatus of the embodiment of the present document further includes a setting unit 24, arranged to: when the smart card is initially set, establish an extended element file of the USB Key, and install the payment application client 23 based on the established extended element file;
herein, the extended element file is used for storing a certificate supporting a USB Key function.

The apparatus of the embodiment of the present document further includes a feedback unit 25, arranged to: feed an execution result of executing the command in the APDU format back to the payment application client 23 via the conversion drive unit 22 after the USB Key processing unit 211 executes the operation corresponding to the command in the APDU format.

The apparatus of the embodiment of the present document further includes a logic channel unit 26, arranged to: transmit the command in the APDU format by configuring a logic channel; and close the logic channel after the feedback unit 25 completes feedback.

The apparatus of the embodiment of the present document further includes a security verification unit 27, arranged to: before the USB Key processing unit 211 receives and reads the command in the APDU format, receive a PIN2 code from a user itself, and judge whether the PIN2 code input by the user is consistent with a preset PIN2 code of the terminal; if consistent, consider that the PIN2 code input by the user is matched with the preset PIN2 code of the terminal, and open a USB Key function of the smart card 21 to make it under an enabled state; and if the input PIN2 code is not matched with the preset PIN2 code and non-match times reach preset times, prohibit all of subsequent payment operations.

The present document is clearly illustrated in detail by specific embodiments below, and the embodiments are not intended to limit the scope of protection of the present document.

### EMBODIMENT 1

In this embodiment, a smart card is set as an SIM. The embodiment is illustrated by taking the SIM as an example.

Step 300: An extended element file (e.g., Element File (EF) USB Key) is established on an SIM card, and is used for storing a certificate supporting a USB Key function. A payment application client is installed based on the established extended element file.

Step 301: A USB Key and a USB Key processing unit are disposed in the SIM card.

Step 302: The payment application client sends a command related to the USB Key, and judges whether the command related to the USB Key is a command in an APDU format which is capable of being identified by the USB Key processing unit. If yes, step 3030 is executed, otherwise, step 3040 is executed.

Step 3030: The smart card receives a PIN2 code from a user, and judges whether the PIN2 code input by the user is consistent with a preset PIN2 code of a terminal. If consistent, it is considered that the PIN2 code input by the user is matched with the preset PIN2 code of the terminal, and the USB Key function of the smart card is opened to make it under an enabled state. Step 30310 is executed.

If the input PIN2 code is not matched with the preset PIN2 code and non-match times reach preset times, all of subsequent payment operations are prohibited. Step 30311 is executed.

Step 30310: The payment application client directly transmits the command in the APDU format to the USB Key processing unit via a logic channel.

Step 30311: All of the payment operations are prohibited.

Step 3040: A conversion drive unit converts the command related to the USB Key to the command in the APDU format. Here, the conversion drive unit converting the command related to the USB Key to the command in the APDU format specifically includes: the conversion drive unit parses the command related to the USB Key, according to the preset APDU format, fills parsed command information in an APDU corresponding position and fills the related parameter.

Step 3041: The smart card receives the PIN2 code from the user, and judges whether the PIN2 code input by the user is consistent with the preset PIN2 code of the terminal. If consistent, it is considered that the PIN2 code input by the user is matched with the preset PIN2 code of the terminal, and the USB Key function of the smart card is opened to make it under the enabled state. Step 30410 is executed.

If the input PIN2 code is not matched with the preset PIN2 code and the non-match times reach the preset times, all of the subsequent payment operations are prohibited. Step 30411 is executed.

Step 30410: The conversion drive unit sends the command converted to be in the APDU format to the USB Key processing unit.

After step 30310 or step 30410, step 305 is executed.

Step 30411: All of the payment operations are prohibited.

Step 305: The USB Key processing unit receives and reads the command in the APDU format to activate the USB Key and execute a remote payment instruction, including: an encryption operation, a decryption operation or a key pair generation operation.

Step 306: After executing the operation corresponding to the command in the APDU format, the USB Key processing unit feeds an execution result back to the payment application client via the conversion drive unit, and closes the logic channel after feedback is completed.

Although the implementation mode disclosed by the present application is mentioned above, the contents are only implementation modes adopted to facilitate understanding of the present application, and not intended to limit the present application, such as a specific implementation method in the implementation mode of the present document. Those skilled in the art within which the present application falls may made any modifications and changes in implementation forms and details without departing from the spirit and scope disclosed by the present application. However, the patent protection scope of the present application should refer to the scope defined by the appended claims.

### INDUSTRIAL APPLICABILITY

In the above technical solution, the USB Key is set on the smart card of the mobile terminal, and the smart card receives the command related to the USB Key for remote payment, thus ensuring that the remote payment is implemented securely without the additional hardware cost. Further, the user is securely verified by means of the PIN2 code, thus improving the security of the remote payment. Therefore, the present document has strong industrial applicability.

What is claimed is:

1. A method for implementing a remote payment, applied to a mobile terminal of which a smart card contains a USB Key, a USB Key processing unit being disposed inside the smart card, the method comprising:
sending, by a payment application client, a command related to the USB Key;
converting, by a conversion drive unit, the command related to the USB Key to a command in an Application Protocol Data Unit, APDU, format; and
receiving and reading, by the USB Key processing unit, the command in the APDU format to activate the USB Key and execute a remote payment instruction.

2. The method according to claim 1, wherein, after the payment application client sends the command related to the USB Key, the method further comprises:
judging whether the command related to the USB Key is the command in the APDU format which is capable of being identified by the USB Key processing unit; and
when the command related to the USB Key is the command in the APDU format which is capable of being identified by the USB Key processing unit, directly sending said command to the USB Key processing unit, and executing the step of receiving and reading, by the USB Key processing unit, the command in the APDU format.

3. The method according to claim 1, wherein, the step of converting the command related to the USB Key to the command in the APDU format comprises:
parsing the command related to the USB Key, filling parsed command information in an APDU corresponding position and filling a related parameter according to a preset APDU format.

4. The method according to claim 1, wherein, the step of receiving and reading, by the USB Key processing unit, the command in the APDU format to activate the USB Key and execute the remote payment instruction comprises:
the USB Key processing unit, according to the received and read command in the APDU format, activating the USB Key, and executing an operation of an encryption, a decryption or a key pair generation corresponding to the remote payment.

5. The method according to claim 4, wherein, before the payment application client sends the command related to the USB Key, the method further comprises:
when the smart card is initially set, establishing an extended element file of the USB Key, and installing the payment application client based on the established extended element file;
wherein, the extended element file is used for storing a certificate supporting a USB Key function.

6. The method according to claim 5, wherein, after the USB Key processing unit executes the remote payment instruction corresponding to the command in the APDU format, the method further comprises: feeding an execution result back to the payment application client via the conversion drive unit.

7. The method according to claim 6, wherein, the command in the APDU format is transmitted via a logic channel; and
the method further comprises: after feeding the execution result back to the payment application client, closing the logic channel.

8. The method according to claim 1, wherein, before the USB Key processing unit receives and reads the command in the APDU format, the method further comprises:
receiving, by the smart card, a PIN2 code from a user, and judging whether the PIN2 code input by the user is consistent with a preset PIN2 code of the terminal; if consistent, considering that the PIN2 code input by the user is matched with the preset PIN2 code of the terminal, opening a USB Key function of the smart card to make it under an enabled state, and activating the USB Key; and
if the input PIN2 code is not matched with the preset PIN2 code and non-match times reach preset times, prohibiting all of subsequent payment operations.

9. An apparatus for implementing a remote payment, comprising: a smart card, a conversion drive unit, and a payment application client, wherein,
the payment application client is arranged to: send a command related to a USB Key;
the conversion drive unit is arranged to: after receiving the command related to the USB Key, convert the command related to the USB Key to a command in an Application Protocol Data Unit, APDU, format;
the smart card contains the USB Key, and is provided with a USB Key processing unit, wherein,
the USB Key processing unit is arranged to: receive and read the command in the APDU format to activate the USB Key and execute a remote payment instruction.

10. The apparatus according to claim 9, wherein, the payment application client is further arranged to: after sending the command related to the USB Key, judge whether the command related to the USB Key is the command in the APDU format which is capable of being identified by the USB Key processing unit; and
send said command related to the USB Key directly to the USB Key processing unit when the command related to the USB Key is the command in the APDU format which is capable of being identified by the USB Key processing unit.

11. The apparatus according to claim 9, wherein, the conversion drive unit is arranged to, after receiving the command related to the USB Key, convert the command related to the USB Key to the command in the APDU format by a following way: parsing the command related to the USB Key, filling information about the parsed command related to the USB Key in an APDU corresponding position and filling a related parameter according to a preset APDU format.

12. The apparatus according to claim 9, wherein, the USB Key processing unit is arranged to receive and read the command in the APDU format to activate the USB Key and execute the remote payment instruction by a following way: receiving and reading the command in the APDU format to activate the USB Key and execute an operation of an encryption, a decryption or a key pair generation corresponding to the remote payment.

13. The apparatus according to claim 12, the apparatus further comprising a setting unit, arranged to: when the smart card is initially set, establish an extended element file of the USB Key, and install the payment application client based on the established extended element file;
wherein, the extended element file is used for storing a certificate supporting a USB Key function.

14. The apparatus according to claim 13, the apparatus further comprising a feedback unit, arranged to: feed an execution result of executing the command in the APDU format back to the payment application client via the conversion drive unit after the USB Key processing unit executes the operation corresponding to the command in the APDU format.

15. The apparatus according to claim 14, the apparatus further comprising a logic channel unit, arranged to: transmit the command in the APDU format by configuring a logic channel; and close the logic channel after the feedback unit feeds the execution result back.

16. The apparatus according to claim 9, the apparatus further comprising a security verification unit, arranged to:
before the USB Key processing unit receives and reads the command in the APDU format, receive a PIN2 code from a user, and judge whether the PIN2 code input by the user is consistent with a preset PIN2 code of the terminal; if consistent, consider that the PIN2 code input by the user is matched with the preset PIN2 code of the terminal, and open a USB Key function of the smart card to make it under an enabled state; and
if the input PIN2 code is not matched with the preset PIN2 code and non-match times reach preset times, prohibit all of subsequent payment operations.

17. The apparatus according to claim 9, wherein, the smart card is: a Subscriber Identity Module (SIM) card, or a Universal Subscriber Identity Module (USIM) card, or a Removable User Identity Module (R-UIM) card, or a Secure Digital (SD) card, or a chip which is built in a mobile phone and contains a secure module.

18. The method according to claim 2, wherein, the step of converting the command related to the USB Key to the command in the APDU format comprises:
parsing the command related to the USB Key, filling parsed command information in an APDU corresponding position and filling a related parameter according to a preset APDU format.

19. The method according to claim 2, wherein, the step of receiving and reading, by the USB Key processing unit, the command in the APDU format to activate the USB Key and execute the remote payment instruction comprises:
the USB Key processing unit, according to the received and read command in the APDU format, activating the USB Key, and executing an operation of an encryption, a decryption or a key pair generation corresponding to the remote payment.

20. The apparatus according to claim 10, wherein, the conversion drive unit is arranged to, after receiving the command related to the USB Key, convert the command related to the USB Key to the command in the APDU format by a following way: parsing the command related to the USB Key, filling information about the parsed command related to the USB Key in an APDU corresponding position and filling a related parameter according to a preset APDU format.
